(19) United States
(12) Patent Application Publication
(10) Pub. No.: US 2024/0377329 A1
(43) Pub. Date: Nov. 14, 2024

(54) METHOD AND SYSTEM FOR ACQUIRING CARS SPECTRUM

(71) Applicant: ATONARP INC., Minato-ku, Tokyo (JP)

(72) Inventor: Lukas BRUECKNER, Nieder-Olm (DE)

(73) Assignee: ATONARP INC., Minato-ku, Tokyo (JP)

(21) Appl. No.: 18/292,459

(22) PCT Filed: Aug. 8, 2022
(86) PCT No.: PCT/JP2022/030221

§ 371 Date: Jan. 26, 2024

Related U.S. Application Data
(60) Provisional application No. 63/235,492, filed on Aug. 20, 2021.

(51) Int. Cl. G01N 21/65; G01N 21/63

(52) U.S. Cl. CPC G01N 21/65; G01N 21/636; G01N 2021/653

(57) ABSTRACT

A system includes an optical path for irradiating a part of a target with the Stokes light pulses, the broadband pump light pulses, and the narrowband pump light pulses synchronously; a modulator that is configured to control the phases of the narrowband pump light pulses; and a detector configured to detect CARS spectrum to acquire sets of CARS spectrum in association with the phases of the narrowband pump light pulses.

### TECHNICAL FIELD

The invention generally relates to a system and a method for acquiring CARS (Coherent Anti-Stokes Raman Scattering (Spectroscopy)) spectrum and/or spectra.

### BACKGROUND ART

U.S. Pat. No. 7,388,668 discloses a system for detecting a non-linear coherent field induced in a sample volume. The system includes a first source for generating a first electromagnetic field at a first frequency, a second source for generating a second electromagnetic field at a second frequency, first optics for directing the first and second electromagnetic fields toward the sample volume, second optics for directing the first and second electromagnetic fields toward a local oscillator volume, and an interferometer. The interferometer is for interfering a first scattering field that is generated by the interaction of the first and second electromagnetic fields in the sample volume, with a second scattering field that is generated by the interaction of the first and second electromagnetic fields in the local oscillator volume.

Methods and systems that include detecting spectrum or scattering light of Coherent Anti-Stokes Raman Scattering (CARS) have been applied in a wide range of fields, for example, in the field of biochemicals and structural characterizations of a target of interest of a living subject, particularly for invasive and non-invasive evaluation of the biochemical compositions of a target of interest of a living subject and applications of the same.

### SUMMARY OF INVENTION

However, the CARS spectra include resonant components and non-resonant components. Heterodyne detection using the local oscillation (LO) could have been one of the solutions to acquire resonant constituent from the CARS spectra. This method may include steps of (a) overlapping signal with a coherent, phase-stable LO showing a fixed phase relation with the signal, and (b) scanning phase difference of LO and signal. Phase differences can be controlled by delay stage, single moving mirror, move whole objective (epi), pulse shaper, 2 glass wedges, and the like. Local oscillator sources could be a generator for generating LO signal from 2nd focus on the non-resonant sample, as disclosed in U.S. Pat. No. 7,388,668, external laser. Laser generated by coherent process (NOPA/OPA). Blue-wing of broadband laser (SB-CARS) and the like. However, such a method that acquires LO from outside, i.e., other than the target, includes the problem of time-consuming LO acquisition and switching, in addition to the instability caused by using different optical systems.

One of aspects of this invention is a method comprising: (i) acquiring sets of CARS spectrum by irradiating a part of a target with Stokes light pulses, broadband pump light pulses and narrow band pump light pulses synchronously, varying phases of the narrowband pump pulses; and (ii) extracting resonance constituents by comparing the sets of CARS spectrum acquired. According to the findings of the inventor's simulation, by using the broadband pump, the resonances are smeared out from the spectrum and the spectrum can be used as LO signal or signals. In this method, LO signals can be got by using the broadband pump light pulses from the target with the signals including resonance constituents generated by the narrow band pump light pulses at the same time. Therefore, this method allows the intrinsic interferometric stability, eliminates the need to measure references, does not require switching optics, and improves scanning speed. When switching sample for getting LO and the signals with resonance constituents, there was a possibility of instability factors such as laser drifting. But, in this method, because LO and signals with resonance constituents are acquired from the target using the same optics at the same time, no such changes or drifts will not occur between the measurements of LO and the signals with resonance constituents.

The broadband pump light pulses are selected to generate the local oscillation (LO) signals with the Stokes light pulses and used as LO probe light signals for generating the LO signals. The narrow band pump light pulses are selected to generate signals including resonance constituents with the Stokes light pulses and used as the first probe light signals for generating signals including resonance constituents.

The method may further include scanning the target with the Stokes light pulses, the broadband pump light pulses, and the narrow band pump light pulses to acquire the sets of CARS spectrum at each pixel for performing 2D CARS microscopy imaging. The method may further include scanning the target with the Stokes light pulses, the broadband pump light pulses and the narrow band pump light pulses to acquire the sets of CARS spectrum at each voxel for performing 3D CARS microscopy imaging.

This method can be applied with Time-resolved coherent anti-Stokes Raman scattering, or Time-delayed coherent anti-Stokes Raman scattering (TD-CARS) microscopy. TD-CARS using the probe light pulses in addition to the pulses of the Stokes light and the pump light, is also known as a technique for suppressing non-resonant background by utilizing the different temporal responses of virtual electronic transitions and Raman transitions. The probe light pulses have a delay to the pulses of the Stokes light and the pump light and the excitations due to the Stokes pulses and the pump pulses light are followed by the probe pulses respectively. By the delayed probe pulses, the intensity of LO may be reduced, and the relative intensity of the resonant feature (resonant constituent) may be enhanced.

That is, the acquiring sets of CARS spectrum may include irradiating the part of the target with, in addition to the Stokes light pulses, the broadband pump light pulses and the narrow band pump light pulses, probe light pulses that have a range of wavelengths shorter than that of the narrow band pump light pulses. The probe light pulses may be delayed probe light pulses to the narrow band pump light pulses. The step of acquiring sets of CARS spectrum may include acquiring sets of TD-CARS spectrum, and the step of extracting may include comparing the sets of TD-CARS spectrum acquired.

One of other aspects of this invention is a system comprising: (i) an optical path configured to irradiate a part of a target with Stokes light pulses, broadband pump light pulses and narrow band pump light pulses synchronously; (ii) a modulator configured to control phases of the narrow band pump light pulses; and (iii) a detector configured to detect CARS spectrum generated by the Stokes light pulses, the broadband pump light pulses and the narrow band pump light pulses to acquire sets of CARS spectrum in association with the phases of the narrow band pump light pulses.

Yet one of other aspects of this invention is a computer program or computer program product stored in a non-transitory medium for a computer to operate the system described above. The computer program (program product) includes instructions for controlling the system to acquire the sets of CARS spectrum or TD-CARS spectrum and extracting resonance constituents by comparing the sets of CARS spectrum acquired or TD-CARS spectrum.

### BRIEF DESCRIPTION OF DRAWINGS

The embodiments herein will be better understood from the following detailed description with reference to the drawings, in which:

FIG. 1 depicts an embodiment of a system of this invention;

FIGS. 2(a)-2(d) depict contributions of measured CARS signals;

FIGS. 3(a) and 3(b) depict examples of CARS spectrum when the range of wavelength of pump light pulses are varied;

FIG. 4 depicts an example of CARS spectrum generated with the broadband pump light pulses and the narrow band pump light pulses;

FIG. 5 depicts examples of CARS spectra generated by the broadband pump light pulses and the narrow band pump light pulses with different phases;

FIG. 6 depicts examples of extracted resonance constituents;

FIG. 7 depicts a flow diagram of heterodyne detection method;

FIG. 8 depicts an example of an optical system;

FIGS. 9(a)-9(d) depict examples of the Stokes light pulses, the pump light pulses and CARS signals measured;

FIG. 10 depicts another example of an optical system;

FIGS. 11(a)-11(c) depict examples of the Stokes light pulses, the broadband pump light pulses, the narrow band pump light pulses and CARS signals measured;

FIG. 12 depicts yet another example of an optical system;

FIGS. 13(a) and 13(b) depict examples acquired set of CARS spectrum and extracted resonance constituents;

FIG. 14 depicts another example of a system of this invention; and

FIG. 15 depicts a wavelength plan of TD-CARS.

### DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

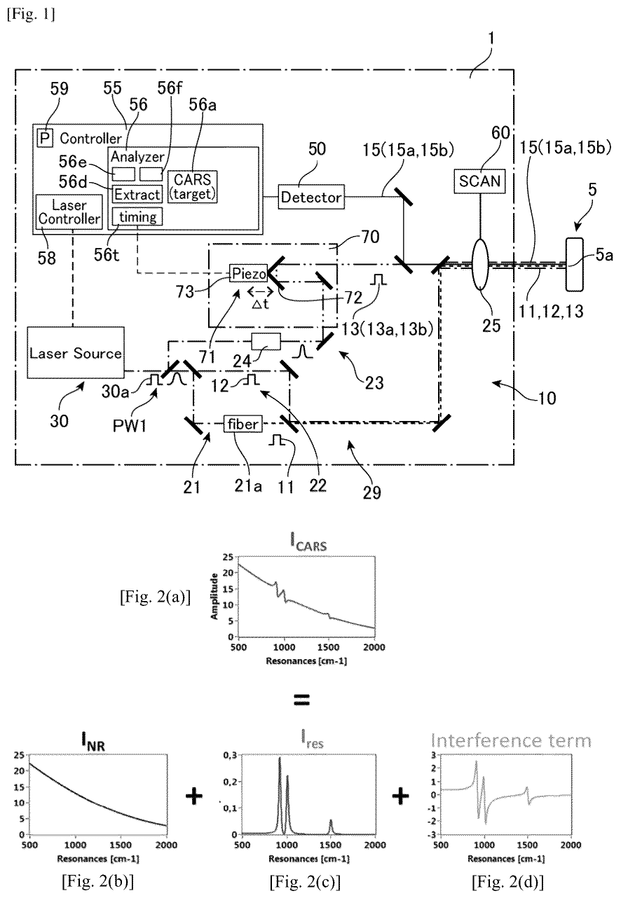

FIG. 1 illustrates a system I according to an embodiment of this invention. The system 1 comprises an optical module 10 that is configured to supply (emit) Stokes light pulses 11, broadband pump light pulses 12 and narrow band pump light pulses 13 for irradiating a part 5a of a target 5 to generate CARS (Coherent Anti-Stokes Raman Scattering or Coherent Anti-Stokes Raman Spectroscopy) signals (CARS spectrums, CARS lights) 15 on the part 5a of the target (object, sample) 5. This system 1 can be used as a measurement device, analyzer, monitoring device, monitor and others depending on the applications. The optical system 10 uses CARS to acquire data indicative of surface and internal conditions and components of a target 5, such as samples in a cuvette or a human body.

The system further comprises a scanner (scanning interface) 60 that is configured to scan the target 5 with the Stokes light pulses 11 and the pump light pulses 12 and 13, and acquire the CARS light 15 from the target 5 through a lens 25 and other optical elements; a modulator 70 that is configured to control phases of the narrowband pump light pulses 13; a detector 50 that is configured to detect the CARS light 15 for analyzing; and a controller 55 that is configured to control the system 1 and the modules such as the scanner 60), the modulator 70, and a laser source 30. The scanning module 60) may be a cuvette, a non-invasive sampler, an invasive sampler, a flow path, or a wearable scanning interface such as a fingertip scanning interface module. The controller 55 includes a laser controller 58 that controls the laser source 30, and an analyzer 56 that analyzes internal compositions (components) by CARS (CARS spectrum). The analyzer 56 may include multiple modules to verify the part 5a of target 5 at which the CARS light 15 is generated. A program (program produce, software. application) 59 stored in the memory of the controller 55 is provided for running the process on the controller 55 with computer resources such as the memory. CPU, and others. The program (software) 59 may be provided as other memory medium (non-transitory medium) readable by a processor or a computer. The program may include instructions for controlling the system 1 to perform the process described in this specification.

The optical system 10 includes a laser source 30 for generating first laser pulses 30a with a first wavelength 1040 nm for the Stokes light pulses (Stokes beam pulses, first light pulses) 11 and the pump light pulses (pump beam pulses, second light pulses) 12 and 13. One of the preferable laser sources 30 is a fiber laser. The first laser pulses 30a have one to several hundred fs (femtosecond)-order pulse widths with tens to hundreds of mW to generate pulses of the Stokes light 11 and the pump lights 12 and 13 with femtosecond-order pulse widths. Pules widths PW1 of the pulses of the Stokes light 11 and the pump lights 12 and 13 may be one to several hundred fs such as 1-900 fs, or may be 10-600 f, or may be 50-400 fs. The optical system 10 includes a plurality of optical elements 29 such as lenses, filters, mirrors, dichroic mirrors and prisms for arranging optical paths to separate and combine the laser light pulses.

The optical system 10 includes a Stokes light path (first optical path. Stokes unit) 21 that is configured to supply the broadband Stokes light pulses (first light pulses) 11 with a first range R1 of wavelengths (for example 1080-1300 nm) from the first laser pulses 30a which are common to the pump light pulses 12 and 13, through the PCF (Photonic Crystal Fiber, fiber, first optical element) 21a included in the Stokes light path 21. The optical system 10 includes a broadband pump light path (second optical path, broadband pump unit) 22 that is configured to supply the broadband pump light pulses (second light pulses) 12 with a second range R2 of wavelengths (for example, the central wavelength is 1040 nm) that is shorter than the first wavelength range (first range) R1 from the first laser pulses 30a which is common to the Stokes light 11. The optical system 10 includes a common optical path that supplies the Stokes light pulses 11 provided by the path 21 and the pump light pulses 12 provided by path 22 to the optical I/O unit (lens system) 25. The optical paths include necessary optical elements such as filters, fibers, dichroic mirrors and prisms to configure each optical path. The same applies to the optical paths described below.

The optical system 10 includes, in addition to the Stokes light path 21 and the broadband pump light path 22, a narrow band pump light path (third optical path, narrow band pump unit) 23 that is configured to supply the narrow band pump light pulses (narrow band pump beam pulses, third light pulses) 13 with a third range R3 of wavelengths (for example, the central wavelength is 1040 nm) from the first laser pulses 30a which is common to the Stokes light 11 and the broadband pump light 12. The optical system 10 includes the common optical path that supplies the narrow band pump light pulses 13 supplied by the path 23 together with the Stokes light pulses 11 and the broadband pump light pulses 12 to the optical I/O unit (lens system) 25.

The third range R3 of wavelengths of the narrow band pump light pulses 13 is narrower than the second range R2 of wavelengths of the broadband pump light pulses 12 and has the same central wavelength as that of the second range R2 of wavelengths. The third optical path 23 includes a second optical element 24 for generating the narrowband pump light pulses 13 from the broadband pump light pulses 12 that may be the first laser pulses 30a. The typical second optical element or elements are optical filters or combinations of filers such as low pass filters and high pass filters for selecting desired band width.

In this system 1, the broadband pump light pulses 12 are selected to include the center wavelength as the pump light and to generate local oscillation (LO) signals with the Stokes light pulses 11. The narrow band pump light pulses 13 are selected to include the same center wavelength as that of the broadband pump light pulses 12 and to generate signals including resonance constituents with the Stokes light pulses 11. FWHM of the second range R2 of wavelengths for the broadband pump light pulses 12 may be 10-100 nm, may be 20-50 nm. In one of the embodiments. FWHM of the second range R2 of wavelengths may be 30 nm. FWHM of the third range R3 of wavelengths for the narrow band pump light pulses 13 may be 1-10 nm, may be 1-5 nm. In one of the embodiments. FWHM of the third range R3 of wavelengths may be 2 nm.

The optical system 10 further includes the optical I/O unit (optical unit) 25 that is configured to coaxially output the Stokes light pulses 11, the broadband pump light pulses 12 and the narrow band pump light pulses 13 to the target 5 synchronously and acquire a CARS light 15 from the target 5 via a common light path. A typical optical I/O unit 25 is an objective lens or lens system that faces to the target 5 and gets backward CARS light pulses (Epi-CARS) 15. The optical system 10 may include an optical path configured to get forward CARS light. In this system 10, the CARS light pulses 15 with a range of wavelengths of 860-980 nm that is shorter than the wavelength range R3 is generated by the broadband pump lights pulses 12 and the narrow band pump light pulses 13 and acquired to be detected by the detector 50.

The optical system 10 includes a modulator (phase modulator, phase controller, time delay unit) 70 that is configured to control phases of the narrow band pump light 13. Typically, the modulator controls (varies, sets, or modulates) a time difference Δt between emissions of the narrow band pump light pulses 13 and emissions of the Stokes light pulses 11 and the broadband pump light pulses 12. The modulator 70) includes a time delay stage (time delay unit) 71 that may include a collimator 72 and an actuator 73 such as a motor or a piezo for modulating a light path (a length of light path) of the narrow band pump light pulses 13. The modulator 70 may include an LC-SLM (Liquid crystal spatial light modulator), an AWG (Arrayed wave-guide grating) and others that control the distance between the collimators.

The relative delay time (time difference, time delay) Δts of the modulator 70 may be varied or set under the control of the timing controller 56t in the controller 55. By using the modulator 70, the narrow band pump light path 23 may supply typically two kinds (types) of the narrow band pump light pulses 13a and 13b with different time differences Δts to have different phases plus and minus Pi/2 ((+/−)π/2) for irradiating at the point 5a of the target 5 via the optical I/O unit 25 to get typically two kinds (types) of CARS pulses 15a and 15b with different phases of resonance components on LO signals by the pulses of the Stokes light 11, the broadband pump light 12 and the narrow band pump light 13. The controller 55 further includes a CARS spectrum acquisition module (CARS acquisition module, CARS acquisitor) 56a. The CARS acquisition module 56a controls the modulator 70 via the timing module 56t to acquire sets of CARS spectrum 15 that include CARS spectrum 15a and 15b in association with the phases of the narrowband pump light pulses 13 by irradiating a part 5a of a target 5 with the Stokes light pulses 11, the broadband pump light pulses 12 and narrow band pump light pulses 13 synchronously, varying only phases of the narrow band pump pulses 13.

The detector 50 is configured to detect CARS spectrum 15a and 15b generated by the pulses of the Stokes light 11, the broadband pump light 12, and the narrow band pump light 13a and 13b to acquire sets of CARS spectrum 15 including spectrums 15a and 15b in association with the phase differences of the narrow band pump light 13a and 13b.

The controller 55 may further includes an extraction module (extractor) 56d, as one of the functions of analyzer 55, configured to extract the resonance constituents (resonant features) Rf from the sets of CARS spectrums 15 by comparing the sets of CARS spectrum acquired to analyze the features or compositions of the part 5a of the target 5. The extraction module 56d may include the functions of scanning the target 5 by using the scanner 60. The scanner 60 that is configured to scan the target 5 with the Stokes light pulses 11, the broadband pump light pulses 12, and the narrow band pump light pulses 13a and 13b to acquire the sets of CARS spectrum 15 at each pixel. The analyzer 56 may include an image generation module (image generator) 56e that generates images (2D images) of the target 5 by the pixels having the resonant features Rf. Accordingly, the system 1 may have the functions of CARS spectroscopy and CARS microscopy.

In CARS spectroscopy, by moving the focus or spot of the Stokes light 11 and the pump light 12 and 13, the system I can generates the depth profile of the target 5. Hence, the scanner 60) may be configured to scan the target 5 with the Stokes light pulses 11, the broadband pump light pulses 12, and the narrow band pump light pulses 13a and 13b in three dimensions to acquire the sets of CARS spectrum 15 at each voxel. The analyzer 56 may include a 3D image generation module (3D image generator) 56f that generates 3D images of the target 5 by the voxels having the resonant features Rf. Accordingly. the system 1 may have the functions of CARS 3D microscopy.

By using a broadband Stokes pulses (Stokes beam) 11, one can excite many resonances at once and record a full spectrum in one shot. Therefore, by scanning the target (sample) 5, full CARS spectrums 15a and 15b can be provided at each pixel or voxel by each shot to make the 2D or 3D CARS imaging in a short time. In addition, by using the system 1, CARS spectrums 15a and 15b that include both LO signals and the resonant features at once at each pixel or voxel from the actual measurement position in the target 5 including tissue and the like. Since differences in generation, optical path, scattering, sample heterogeneity, and other artifacts are cancelled out between the LO signals and the resonant features, the CARS spectrums (spectra) with boosted sensitivity are generated by the system 1.

FIG. 2 shows typical CARS spectrum (light, signals, spectrum, spectra) I_{CARS} (FIG. 2(a)) that includes a component of the non-resonant background I_{NR} (FIG. 2(b)), a component of the resonant feature Iᵣₑₛ (FIG. 2(c)), and a component of the interference term (FIG. 2(d)). CARS electric field E_{CARS} affected by the molecular susceptibility χ⁽³⁾ consists of two fields Eᵣₑₛ and E_{NR} as shown below because the molecular susceptibility χ⁽³⁾ describes molecule properties that includes resonance (amplitude, frequency) and non-resonance (nonres.) contributions. Properties of E_{NR} and Eᵣₑₛ are determined by respective susceptibility component and have intrinsic phase jumps between resonances and non-resonances contributions. Contributions interfere on detector may cause typical dispersive CARS line-shape.

$${E}_{CARS} ∝ {E}_{e x c} ( {χ}_{N R}^{( 3 )} + {χ}_{res}^{( 3 )} )$$

$${E}_{CARS} ∝ {E}_{NR} + {E}_{res}$$

$${I}_{CARS} ∝ {\vert {E}_{res} + {E}_{NR} \vert}^{2}$$

$${I}_{CARS} ∝ {\vert {E}_{res} \vert}^{2} + {\vert {E}_{NR} \vert}^{2} + 2 \vert {E}_{NR} \vert \vert {E}_{res} \vert cos ( Δ ϕ )$$

$$Δϕ = {ϕ}_{res} - {ϕ}_{NR}$$

Resonance and non-resonance contributions show different phase (and polarization) properties. Thus, resonance and non-resonance electrical fields have different phases, but phase information is lost at detection. By using Heterodyne detection where overlapping signal with a coherent reference beam (Local Oscillation, LO) for interferometric detection, the different phase relationships can be exploited to measure amplitude and phase of signal or to separate real and imaginary parts of χ⁽³⁾ as shown below. The heterodyne detection includes a step of overlapping signal with a coherent, phase-stable LO showing a fixed phase relation with the signal and a step of scan phase difference of LO and signal.

Local oscillator sources could be generated from 2nd focus (non-resonance sample), an external laser, a laser generated by coherent process (NOPA/OPA) or Blue-wing of broadband laser (SB-CARS). However, it is necessary to measure the reference to obtain the LO signals, and it takes time to switch between LO source and sample (target) measurement. In addition, fluctuations caused by switching optics, e.g., laser drafts, may cause differences in measurement conditions between the non-resonant and resonant components, making accurate measurement difficult. Therefore, it should be desirable to obtain the local oscillation (LO), instead of using the local oscillator volume, using only the sample to be measured (target).

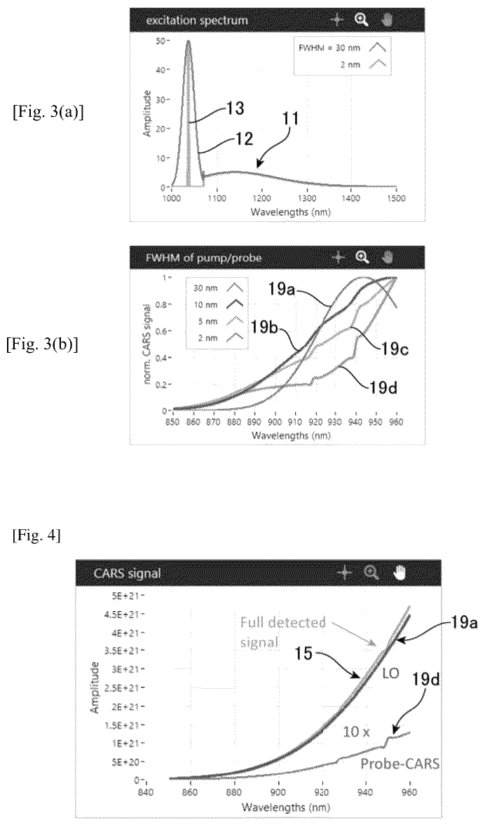

FIGS. 3 to 6 show the concept of this invention by some results of the simulation. According to the findings of the inventor's simulation, by using the fairly broad pump signal (broadband pump light pulses, second probe light pulses) 12, resonances are smeared out and LO signals can be acquired from the target sample 5. Therefore, by emitting the narrow pump signal (narrow band pump light pulses first probe light pulses) 13 to the target sample 5 with the broadband pump light pulses 12, resonance constituent can be obtained using Heterodyne detection without switching the optics between LO source and the target sample.

As shown in FIG. 3, by using a combination of the broadband pump pulses 12 with FWHM of 30 nm and the Stokes light pulses 11 in FIG. 3 (a), unspecific broad signal 19a shown in FIG. 3(b) is generated. By using a combination of the narrow band pump pulses 13 with FWHM of 2 nm and the Stokes light pulses 11 in FIG. 3 (a), a signal 19d that includes resonant features is obtained. Signals 19b and 19c shown in FIG. 3 (b) are obtained using the pump light pulses with FWHM of 10 nm and 5 nm respectively.

As shown in FIG. 4, in the broad signal 19a obtained by the broadband pump pulses 12, resonances are smeared out and the broad signals 19a can be obtained stably and constantly by the broadband pump pulses 12. Therefore, the broad signal 19a can be used as the LO (local oscillation) signals. In addition, by adding the narrow band pump pulses 13 to the broadband pump pulses 12, CARS signals 15 with resonance component 19d on LO 19a can be obtained. In this method, the LO signals 19a generated by the broadband pump pulses 12 can amplify the resonance components (resonant features) 19d raised by the narrow band pump pulses 13, but the narrow band pump pulses 13, which is the probe pulses to acquire resonant features, can be independently controlled to exploit phase differences. Relative phases of the resonance components between the signals 19a and 19d can be controlled by controlling the phase of the narrow band pump pulses 13 or controlling interferences.

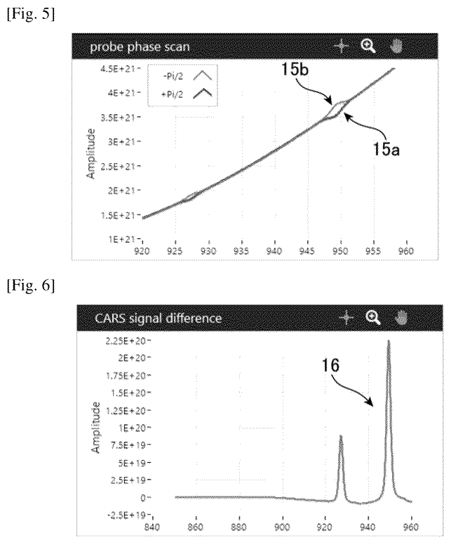

FIG. 5 shows examples of the CRAS spectrum 15a and 15b generated by using the broadband pump light pulses 12 and the narrow band light pulses 13a and 13b with varying the phase of the narrow band pump light pulses plus and minus Pi/2(+/−π/2) respectively. As shown in FIG. 5, the CARS spectrum 15a and 15b are created by combining or mixing the LO signals and the resonance components and the response components are installed or carried on the LO signals as the plus and minus modulated signals according to the phases of narrow band pump light pulses 13a and 13b. Therefore, as shown in FIG. 6, the resonance constituents can be extracted by comparing the acquired CAS spectrums 15a and 15b (sets of CARS spectrum).

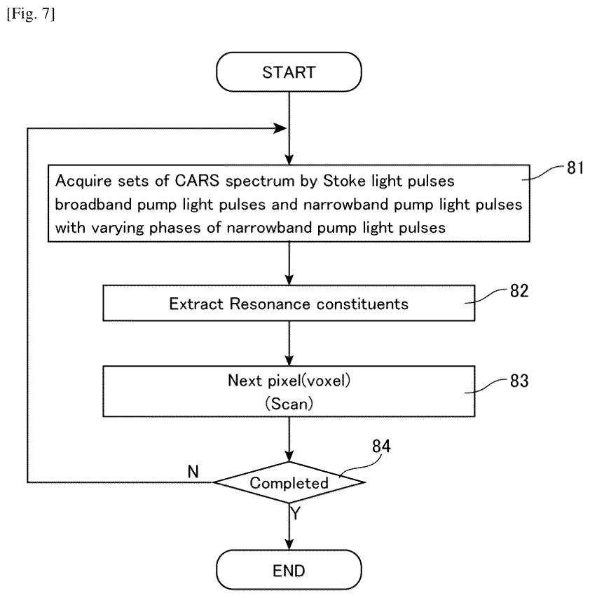

FIG. 7 is a flow diagram showing an overview of the process of this heterodyne detection method. The method includes acquiring sets of CARS spectrum (step 81) and extracting resonance constituents (resonance components, resonant features) by comparing the sets of CARS spectrum acquired (step 82). In step 81, the sets of CARS spectrum 15 are acquired by irradiating a part 5a of a target 5 with the Stokes light pulses 11, the broadband pump light pulses 12, and the narrow band pump light pulses 13 varying the phases of the narrow band pump light pulses 13. The broadband pump light pulses 12 are selected to generate the local oscillation (LO) signals with the Stokes light pulses 11, and the narrow band pump light pulses 13 are selected to generate signals including the resonance constituents with the Stokes light pulses 11.

The method may further include a step of scanning the target 5 (step 83). In the step 83, the target 5 is scanned with the Stokes light pulses 11, the broadband pump light pulses 12, and the narrow band pump light pulses 13 to acquire the sets of CARS spectrum 15 at each pixel to generate an image of the target 5. The step 83 may be the 3D scanning to acquire the sets of CARS spectrum 15 at each voxel to generate a 3D image of the target 5. In step 84, the above steps may be repeated until all pixel or voxel information is obtained.

In the system 1 and the method of this invention that uses the LO signals generated by the broadband pump light pulses 12, the LO signals are acquired from the target 5 with the resonance compositions at the same time by using the narrow band light pulses 13 together with the broadband pump light pulses 12. Hence, no reference as an LO source is needed, and furthermore, the time and effort of measuring the reference and the optics for measuring that are not required. In addition, the influence of unstable elements in the measurement system, such as laser drift, can be greatly reduced because there is no need to change optical system conditions or spend time between those measurements to switch between reference and sample (target). Measurement can be performed only (just) varying the phases of the narrowband pump light pulses 13. Therefore, the system 1 of this invention has an intrinsic interferometric stability and, by using the system 1 and the heterodyne detection method of this invention, information on resonance components in CARS spectra (signals) can be obtained with high accuracy, thereby enabling information on target components to be analyzed with higher precision, making quantitative as well as qualitative measurements possible.

In the system 1 and the method of this invention, the LO signals are acquired from the target 5 with no need for reference measurement, therefore kHz phase scan/switching rates should be possible. Using the system 1 and this heterodyne detection method, information having linear concentration dependence can be acquired and signals amplification can be controlled by the intensity of the LO signal generated by the broadband pump light pulses 12. It should be noted that the LO signals and resonant signal are not independent. If the LO signals are too strong and about dynamic range of detector 50, only way to reduce the LO signal is to reduce the broadband pump light pulses, which also reduces resonant excitation. However, the concept of this invention is theoretically possible to combine with TD-CARS as explained below. By using TD-CARS, the resonance constituents may be extracted without reducing the LO signal intensities.

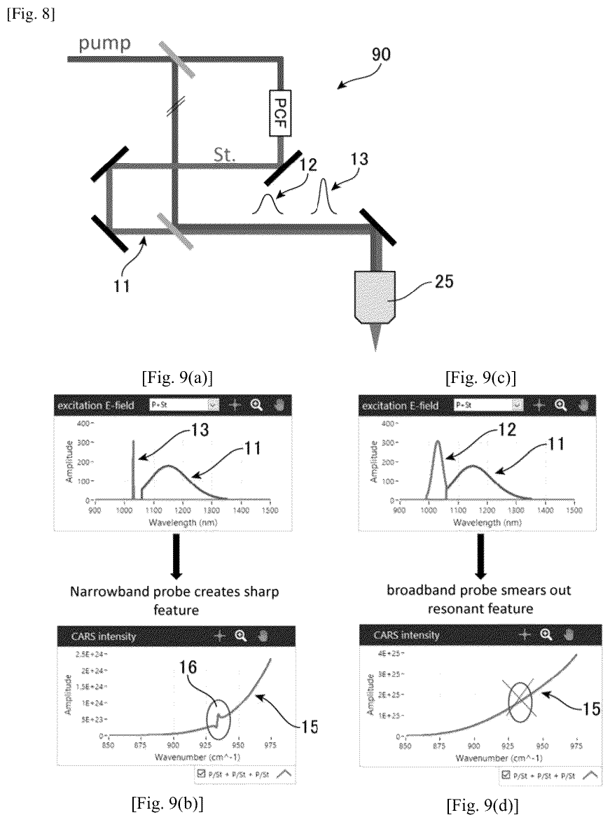

FIGS. 8 to 13 are used to further explain the concepts of this invention. These figures show some examples from simulations. FIG. 8 shows an optical system 90 that emits the Stokes light pulses 11 and one of the broadband pump pulses 12 and the narrow band pump pulses 13. In the case of the Stokes pulses 11 and the narrowband pump pulses 13 radiated (FIG. 9(a)), the narrowband pump (narrow band probe, the first probe) pulses 13 create the CARS spectrum (scattered light, the first scattered light) 15 that includes sharp feature of the resonant feature 16 (FIG. 9(b)). In the case of the Stokes pulses 11 and the broadband pump pulses 12 radiated (FIG. 9(c)), the broadband pump (broadband probe, the second probe) pulses 12 smear out resonant feature and creates the CARS spectrum (scattered light, the second scattered light) 15 that includes only the non-resonant components (features) (FIG. 9(d)).

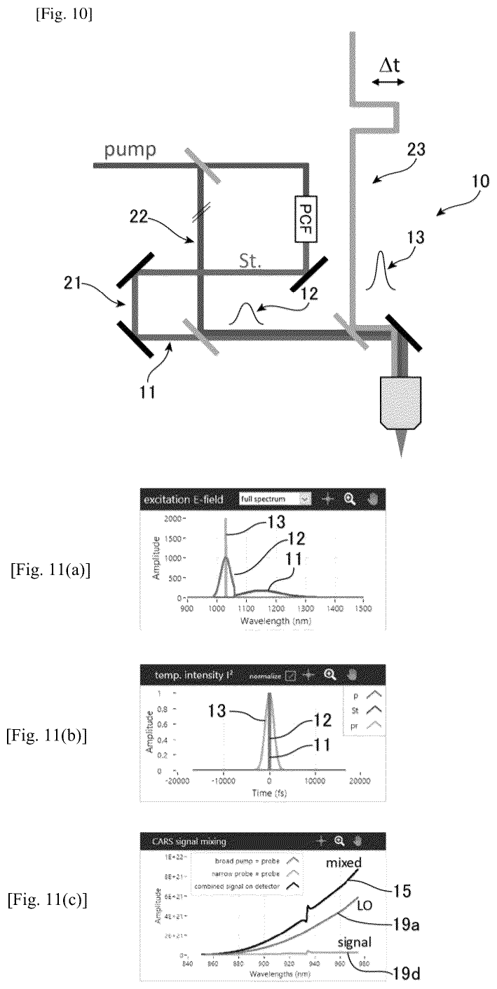

FIG. 10 shows an optical system 10 that emits the Stokes light pulses 11 and both the broadband pump pulses 12 and the narrow band pump pulses 13 synchronously to combine both approaches shown in FIG. 9. As shown in FIG. 11(a), the Stokes light pulses 11 have broadband Stokes beams. The Stokes light pulses 11 have first range of wavelengths, the broadband pump light pulses 12 have second range of wavelengths that is shorter than the first range of wavelengths, and the narrow band pump light pulses 13 have third range of the wavelengths that is narrower than the second range of wavelengths and has a same central wavelength as that of the second range of wavelengths.

As shown in FIG. 11(b), when the Stokes light pulses (St) 11, the broadband pump light pulses (p1) 12 and the narrow band pump pulses (p2) 13 are simultaneously emitted to the target sample via output lenses and temporally overlapped on the target, all kinds of interaction will take place (p1/St, p1/p2, St/St, p2/p2, etc.). As shown in FIG. 11(c), the broadband pump pulses 12 act as the pump pulses that generate the spectrum smeared out resonant feature 19a that is used as the LO signal. The narrow band pump pulses 13 generate the resonant signals 19d. Those signals generated by the broadband pump pulses 12 and the narrow band pump pulses 13 are not totally independent as the excitation is due to p1/St interactions in both cases. But for the LO signal, broadband pump pulses 12 are ‘used’ twice, therefore, relative CARS intensities can be controlled by changing power of the broadband pump pulses 12.

By changing the phase of the narrow band pump pulses 13, we can generate following two interfering CARS signal with independent relative phases.

(a) p1/St+p1 (broad pump (no influence of probe phase))

(b) p1/St+p2 (narrow pump (probe))

The relative phase between the two can now be controlled by changing the phase of the narrow band pump pulses 13. As an option the system 1 may additionally include time-delay stage to the narrow band pump pulses 13. The system 1 may include blocking device for the narrow band pump pulses 13. The system 1 can get the LO signal only for need to check if that is helpful in measurement/analysis.

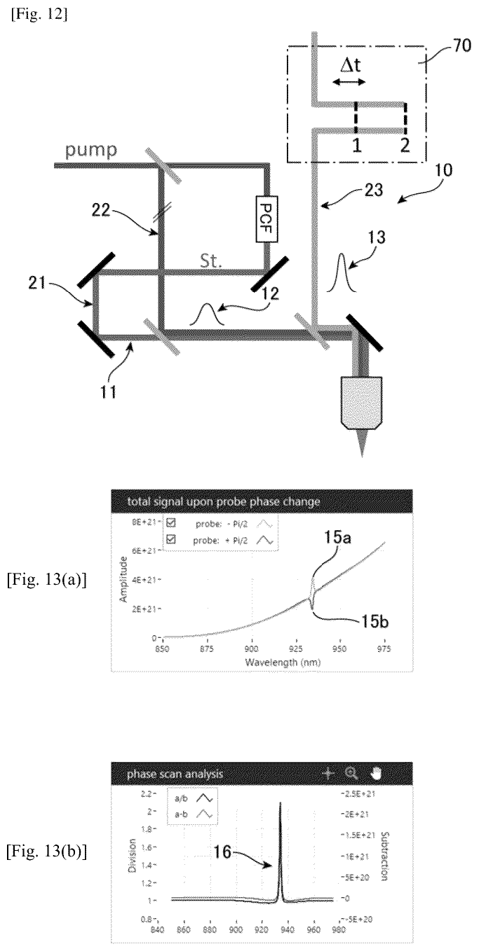

FIG. 12 shows an optical system 10 that includes the modulator 70) that enables KHZ switching the phase of the narrow band pump pulses (probe pulses) 13. By using the optical system 10, the sets of CARS spectrum (CARS spectra) with resonance components in opposite phase are obtained as shown in FIG. 13(a). By comparing (by taking the differences, subtractions, or ratios), the resonance constituents (resonant features) can be extracted as shown in FIG. 13(b). The system 1 may include additional amplitude switching (LO on/off) by chopper wheel etc.

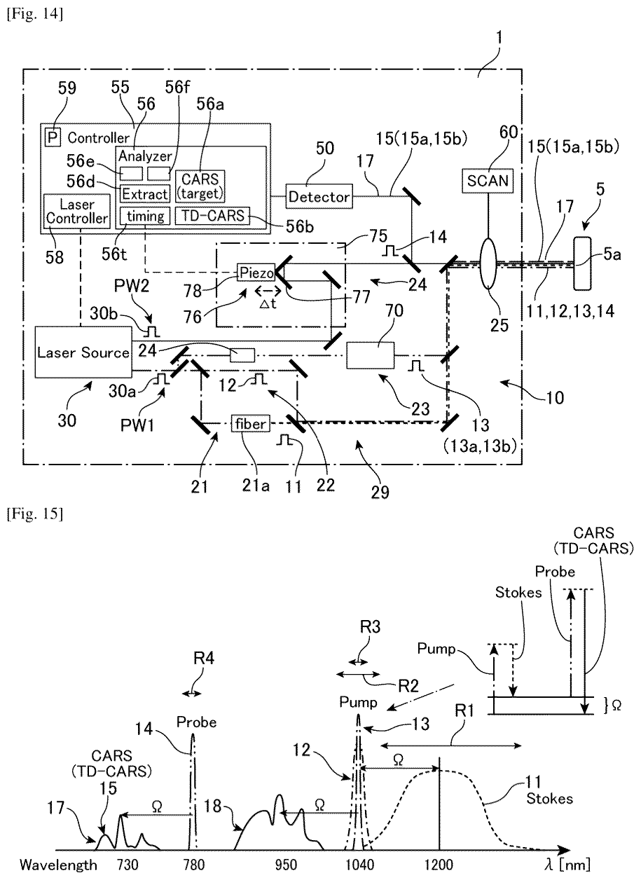

FIG. 14 illustrates another embodiment of the system 1. The optical system 10 of this system 1 further includes a fourth optical path 24 configured to supply probe light (time delayed probe light, TD-probe light, delayed probe light) pulses 14 that have a range of wavelengths shorter than that of the narrow band pump light pulses 13 for irradiating the part 5a of the target 5 together with the Stokes light pulses 11, the broadband pump light pulses 12, and the narrow band pump light pulses 13. The fourth optical path 24 includes a delay element (second modulator) 75 to supply the probe light pulses 14 as delayed probe light pulses to the narrow band pump light pulses 13. The detector 50 is configured to detect TD-CARS spectrum 17 generated by the delayed probe light pulses 13 in addition to the Stokes light pulses 11, the broadband pump light pulses 12, and the narrow band pump light pulses 13, as the set of CARS spectrum 15. The analyzer 56 in the controller 55 is configured to extract resonance constituents by comparing the sets of TD-CARS spectrum 15 acquired.

The analyzer 50) includes a TD-CARS acquisition module (TD-CARS acquisitor) 56b that controls the modulator 75 via the timing module 56t to acquire the TD-CARS spectrums 17 by irradiating a part 5a of a target 5 with the probe light 14 with a relative temporal relationship (delay) Δt to the emission of the pulses of the Stokes light 11 and the pump lights 12 and 13, and the pulses of the Stokes light 11 and the pump lights 12 and 13, and the pulses of probe light 14 do not substantially overlap each other. The modulator 75 may include a time delay stage (time delay unit) 76 that may include a collimator 77 and an actuator 78 such as a motor or a piezo for modulating a light path (a length of light path) of the probe light pulses 14.

The laser source 30) may generate, in addition to the first laser pulse 30a with a first wavelength 1040 nm for the Stokes light pulses 11 and the pump light pulses 12 and 13, a second laser pulses 30b with a second wavelength 780 nm for the probe light pulses 14. The second laser pulses 30b may include one to several tens ps (picosecond)-order pulses with tens to hundreds of mW to generate pulses of the probe light 14 with picosecond order pulse widths. Pules widths PW2 of the pulses of the probe light 14 may be one to several tens ps such as 1-90 ps, or may be 1-50 ps, or may be 2-10 ps. The second laser pulses 30b with the wavelength of 780 nm may be generated from the source oscillator with a wavelength of 1560 nm.

FIG. 15 shows a wavelength plan of the concept of TD-CARS. Stokes light pulses 11 have the first range R1 of wavelengths 1085-1230 nm (400 cm⁻¹˜1500 cm⁻¹). The broadband pump light pulses 12 have the second range R2 of wavelengths including the central wavelength 1040 nm. The narrow band pump light pulses 13 have the third range R3 of the wavelengths that is narrower than the second range R2 of wavelengths and has a same central wavelength (1040 nm) as that of the second range R2 of wavelengths. The CARS spectrum (signal) 18 is generated by the Stokes light pulses 11 and the pump light pulses 12 and 13 at the wavelengths corresponding to the molecular vibration 22 from the wavelength of the narrow band pump light (that is the probe light) pulses 13.

The Probe light pulses 14 have the fourth range R4 of the wavelengths 780 nm that is shorter than the third range R3 of wavelengths of the narrow band pump light pulses 13. TD-CARS light (signal, spectrum) 17 has the range of the wavelengths 680-760 nm. The TD-CARS 17 having the wavelength range shorter than the range R4 of the probe light 14 is generated. That is, by using the probe light pulses 14 with the range R4 of wavelengths shorter than the range of wavelengths of the CARS light 18 only generated by the Stokes light pulses 11 and the pump light pulses 12 and 13 with a time difference from the emission of the pump light pulses 12 and 13, the TD-CARS 17 having the wavelength range shorter than the wavelength range of the CARS light 18 is generated. Accordingly, no interference is made between the TD-CARS 17 and the CARS 18, and distinct TD-CARS 17 can be detected without interference with the CARS light 18 by the detector 50 as the set of CARS spectrum 15.

TD-CARS signals 17 are generated by the time delayed probe light pulses 14. Because the non-resonant component decays during the delay, the resonant component appears relatively strong in TD-CARS 17. Therefore, if the LO signals generated by the broadband pump lights pulses 12 in the CARS signals 18 are so high, it could be assumed that converting to TD-CARS signals 17 may attenuate the non-resonant component (LO), and the resonance components 16 may be extracted more clearly and accurately by using the TD-CARS signals 17 as the set of CARS spectrum 15.

As explained above the method and the system for adapting the heterodyne detection are provided. The disclosed heterodyne detection is applicable to any kind of CARS measurement including forward and backscattered CARS. The disclosed heterodyne detection can get LO signals from the same sample (target) 5 from which the resonant component 16 to be get by using multiple beams system.

The method and the system described in this specification may be applicable for biochemical and structural characterization of a target of interest of a living subject, particularly for invasive and non-invasive evaluation of the biochemical compositions of a target of interest of a living subject and applications of the same. The method and the system described in this specification may be applicable for all kinds of samples, also simpler samples like solutions independent of biochemistry.

In this specification, a system is disclosed that comprises: a first optical path configured to supply the first light pulses to a sample for causing generation of scattered light that contains resonant components; a second optical path configured to supply the first probe light pulses with a first probe light wavelength to the sample to generate first scattered light with the resonant components; a third optical path configured to supply the second probe light pulses with the first probe light wavelength and wider range of wavelengths than that of the first probe light pulses to the sample to generate second scattered light functioning as LO (local oscillation); an optical I/O unit configured to emit the first light pulses, the first probe light pulses and the second probe light pulses to the target sample and acquire scattered lights from the target sample; and an analyzer configured to acquire the resonant components from the first scattered light and the second scattered light. By using the first probe light pulses with a first probe light wavelength, the first scattered light with the resonant components and non-resonant components is acquired from the target sample, and by using the second probe light pulses with the first probe light wavelength and wider range of wavelengths than that of the first probe light pulses, the second scattered light functioning as LO is acquired from the target sample generated. Therefore, in this system. LO from the same target sample is acquired by combining different excitation schemes.

The system may further comprise a first modulating unit configured to vary phase of the first probe light pulses. In one embodiment, the first optical path may be configured to supply Stokes light pulses as the first light pulses with a first range of wavelengths; the second optical path may be configured to supply first pump light pulses that functions as the first probe light pulses with a second range of wavelengths shorter than the first range of wavelengths; the third optical path may be configured to supply second pump light pulses that functions as the second probe light pulses with a third range of wavelengths shorter than the first range of wavelengths; and the analyzer may be configured to acquire the resonant components of CARS signal from the target sample.

In another embodiment, the first optical path may be configured to supply Stokes light pulses as the first light pulses with a first range of wavelengths, and the system further comprises an optical path configured to supply pump light pulses with a range of wavelengths shorter than the first range of wavelengths. The second optical path may be configured to supply the first probe light pulses with a second range of wavelengths shorter than the range of wavelengths of the above pump light pulses; the third optical path may be configured to supply the second probe light pulses with a third range of wavelengths shorter than the range of wavelengths of the above pump light pulses; and the analyzer may be configured to acquire the resonant components of TD-CARS signal from the target sample. In yet another embodiment, the first optical path may include a chirped pulse amplifier. The method may include modulating the first probe light pulses to vary phase of the first probe light pulses.

In this specification, a method is also disclosed. The method comprises: (i) emitting the first light pulses the first probe pulses and the second probe pluses together to a target sample, the first light pulses being for causing generation of scattered light that contains resonant components, the first probe light pulses having a first probe light wavelength for generating first scattered light with the resonant components, the second probe light pulses having the first probe light wavelength and wider range of wavelengths than that of the first probe light pulses for generating second scattered light functioning as LO; and (ii) acquiring the resonant components from the first scattered light and the second scattered light acquired from the target sample emitting and acquiring. The method may further include modulating the first probe light pulses to vary phase of the first probe light pulses.

The emitting may include: supplying Stokes light pulses as the first light pulses with a first range of wavelengths; supplying the first pump light pulses that functions as the first probe light pulses with a second range of wavelengths shorter than the first range of wavelengths; and supplying the second pump light pulses that functions as the second probe light pulses with a third range of wavelengths shorter than the first range of wavelengths. The acquiring may include acquiring the resonant components of CARS signal from the target sample.

The emitting may include: supplying Stokes light pulses as the first light pulses with a first range of wavelengths; supplying pump light pulses with a range of wavelengths shorter than the first range of wavelengths; supplying the first probe light pulses with a second range of wavelengths shorter than the range of wavelengths of the above pump light pulses; and supplying the second probe light pulses with a third range of wavelengths shorter than the range of wavelengths of the above pump light pulses. The acquiring may include acquiring the resonant components of TD-CARS signal from the target sample.

In this specification a computer program (program product) for a computer to operate a device is disclosed. The device comprises: a first optical path configured to supply first light pulses to a sample for causing generation of scattered light that contains resonant components; a second optical path configured to supply first probe light pulses with a first probe light wavelength to the sample to generate first scattered light with the resonant components; a third optical path configured to supply second probe light pulses with the first probe light wavelength and wider range of wavelengths than that of the first probe light pulses to the sample to generate second scattered light functioning as LO; and an analyzer configured to detect the first scattered light and the second scattered light. The computer program includes executable codes for performing steps of: emitting the first light pulses, the first probe pulses and the second probe pluses together to a target sample; and acquiring the resonant components from the first scattered light and the second scattered light.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

1. A method comprising:
acquiring sets of CARS spectrum by irradiating a part of a target with Stokes light pulses, broadband pump light pulses and narrowband pump light pulses synchronously, varying phases of the narrowband pump pulses; and
extracting resonance constituents by comparing the sets of CARS spectrum acquired.

2. The method according to claim 1, wherein the broadband pump light pulses are selected to generate local oscillation (LO) signals with the Stokes light pulses, and the narrowband pump light pulses are selected to generate signals including resonance constituents with the Stokes light pulses.

3. The method according to claim 1, further comprising scanning the target with the Stokes light pulses, the broadband pump light pulses, and the narrowband pump light pulses to acquire the sets of CARS spectrum at each pixel.

4. The method according to claim , further comprising scanning the target with the Stokes light pulses, the broadband pump light pulses and the narrowband pump light pulses to acquire the sets of CARS spectrum at each voxel.

5. The method according to claim 1, wherein the Stokes light pulses have first range of wavelengths, the broadband pump light pulses have second range of wavelengths that is shorter than the first range of wavelengths, and the narrowband pump light pulses have third range of the wavelengths that is narrower than the second range of wavelengths and has a same central wavelength as that of the second range of wavelengths.

6. The method according to claim 1, wherein the Stokes light pulses have broadband Stokes beams.

7. The method according to claim 1, wherein the acquiring sets of CARS spectrum includes irradiating the part of the target with, in addition to the Stokes light pulses, the broadband pump light pulses and the narrowband pump light pulses, probe light pulses that have a range of wavelengths shorter than that of the narrowband pump light pulses.

8. The method according to claim 7, wherein the probe light pulses are delayed probe light pulses to the narrowband pump light pulses,
the acquiring sets of CARS spectrum includes acquiring sets of TD-CARS spectrum; and
the extracting includes comparing the sets of TD-CARS spectrum acquired.

9. A system comprising:
an optical path configured to irradiate a part of a target with Stokes light pulses, broadband pump light pulses and narrowband pump light pulses synchronously;
a modulator configured to control phases of the narrowband pump light pulses; and
a detector configured to detect CARS spectrum generated by the Stokes light pulses, the broadband pump light pulses and the narrowband pump light pulses to acquire sets of CARS spectrum in association with the phases of the narrowband pump light pulses.

10. The system according to claim 9, wherein the optical path includes:
a first optical path configured to supply the stokes light pulses with first range of wavelengths;
a second optical path configured to supply the broadband pump light pulses with second range of wavelengths that is shorter than the first range of wavelengths; and
a third optical path configured to supply the narrowband pump light pulses with third range of the wavelengths that is narrower than the second range of wavelengths and has a same central wavelength as that of the second range of wavelengths.

11. The system according to claim 10, wherein the first optical path includes a first optical element for generating broadband Stokes beams from the broadband pump light pulses.

12. The system according to claim 10, wherein the third optical path includes a second optical element for generating the narrowband pump light pulses from the broadband pump light pulses.

13. The system according to claim 9, further comprising a scanner that is configured to scan the target with the Stokes light pulses, the broadband pump light pulses and the narrowband pump light pulses to acquire the sets of CARS spectrum at each pixel.

14. The system according to claim 9, further comprising a scanner that is configured to scan the target with the Stokes light pulses, the broadband pump light pulses and the narrowband pump light pulses to acquire the sets of CARS spectrum at each voxel.

15. The system according to claim 9, further comprising an analyzer that is configured to extract resonance constituents by comparing the sets of CARS spectrum acquired.

16. The system according to claim 9, wherein the optical path includes a fourth optical path configured to supply probe light pulses that have a range of wavelengths shorter than that of the narrowband pump light pulses for irradiating the part of the target together with the Stokes light pulses, the broadband pump light pulses and the narrowband pump light pulses.

17. The system according to claim 16, wherein the fourth optical path includes a delay element to supply the probe light pulses as delayed probe light pulses to the narrowband pump light pulses, and
the detector is configured to detect TD-CARS spectrum generated by the delayed probe light pulses in addition to the Stokes light pulses, the broadband pump light pulses, and the narrowband pump light pulses.

18. The system according to claim 17, further includes an analyzer that is configured to extract resonance constituents by comparing the sets of TD-CARS spectrum acquired.

19. A nontransitory computer readable medium encoded with a computer program for a computer to operate the system according to claim 9, wherein the computer program includes instructions for controlling the system to acquire the sets of CARS spectrum and extracting resonance constituents by comparing the sets of CARS spectrum acquired.

20. A nontransitory computer readable medium encoded with a computer program for a computer to operate the system according to claim 17, wherein the computer program includes instructions for controlling the system to acquire the sets of TD-CARS spectrum and extracting resonance constituents by comparing the sets of TD-CARS spectrum acquired.
